(19) United States
(12) Patent Application Publication
(10) Pub. No.: US 2008/0220710 A1
(43) Pub. Date: Sep. 11, 2008

(54) Method and Device for Controlling an Air Flow in the Interior of a Motor Vehicle

(75) Inventors: Peter Nonnenmacher, Gaertringen (DE); Wolfgang Straub, Deggingen (DE); Thomas Vinnemann, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/884,369

(22) PCT Filed: Jan. 27, 2006
(86) PCT No.: PCT/EP06/00706

§ 371 Date: Apr. 1, 2008

(30) Foreign Application Priority Data
Feb. 16, 2005 (DE) 10 2005 006 946.0

(51) Int. Cl. B60H 1/00

(52) U.S. Cl. 454/75

(57) ABSTRACT

In a method and apparatus for controlling air flow in the interior of a motor vehicle, when a threshold speed is exceeded, storage of an error message in an air conditioning control appliance is prevented. For this purpose, the device has corresponding sensor systems in order to define parameters which are used for determining the threshold speed.

### BACKGROUND AND SUMMARY OF THE INVENTION

This application is a national stage of PCT International Application No. PCT/EP2006/000706, filed Jan. 27, 2006, which claims priority under 35 U.S.C. § 119 to German Patent Application No. 10 2005 006 946.0, filed Feb. 16, 2005, the disclosure of which is expressly incorporated by reference herein.

The present invention relates to a method and apparatus for controlling an air flow in the interior of a motor vehicle.

European patent document EP 0 428 523 B1 discloses an air conditioning system for a motor vehicle, which controls the air pressure in the passenger compartment by means of two separate fans in such a manner that, when the doors and windows are closed or the sliding roof is closed, the air pressure prevailing in the passenger compartment is always somewhat greater than the ambient pressure. An electronic evaluation system ensures that the fans do not start up if there is a sudden drop in pressure in the interior, as would be the case if a window, a door or a sliding roof were opened. The fans have to be activated differently, depending on the driving state, in order to permit appropriate control of the pressure. This causes the speed of the air emerging into the interior through the outlet nozzles to change constantly, which is perceived as unpleasant by the vehicle occupants.

To eliminate this problem, German patent document DE 101 32 891 A1 provides an air conditioning device which uses just one fan, which can be set as a function of the vehicle speed and the positions of the individual vehicle openings (doors, windows, sliding roof). As a result, the air outlet speed into the passenger compartment remains essentially constant even if the pressure in the interior is subject to considerable fluctuations.

At high vehicle speeds, a very high dynamic pressure is present on the suction side of the interior fan if the air conditioning device is operated in the fresh air mode. If a window or a sliding roof of the motor vehicle is opened at such high vehicle speeds, a negative pressure forms on the delivery side of the fan of the air conditioning device (i.e., in the interior of the motor vehicle). This is also the case to a considerable extent if the motor vehicle is a convertible which is being driven with the top down.

If a dynamic pressure is present on the suction side and a negative pressure is present on the delivery side, a critical operating state arises for the air conditioning device and, under certain circumstances, may cause the internal protective function of the fan regulator to switch off the fan temporarily, in order to prevent it from starting up in the overloaded state.

Air conditioning devices currently used in motor vehicles have an air conditioning control unit which generates an error message and stores it in a local memory when a critical operating state of this type occurs. This stored error message generally requires that the fan regulator (or under some circumstances, the entire fan) be replaced in the workshop, even though the components of these devices are satisfactorily functional. This result is undesirable for warranty and cost reasons, since the appliances are in order and have been stopped from functioning merely because of one or more brief protective switching-off operations which were for protecting the fan or the fan regulator against overheating.

One object of the present invention is to provide an improved method and apparatus for controlling the air flow in the interior of a motor vehicle.

Another object of the invention is to provide an air conditioning device that implements said method, in such a manner that unnecessary maintenance operations and costs are avoided.

These and other objects and advantages are achieved by the method and apparatus according to the invention in which when a certain threshold speed is exceeded, storage of an error message in the air conditioning control unit is prevented.

In the event of an error, the fan is switched off (protective switching operation), and therefore must be switched on again. The fan is therefore triggered. Accordingly, a further step of the method according to the invention, the air conditioning control unit switches off the fan if the vehicle speed drops below a certain threshold value, and thereafter immediately switches it on again (retriggering).

The threshold vehicle speed is determined as a function of positions of the vehicle openings, such as, for example, of at least one window and/or of a sliding roof of the motor vehicle. In the case of a convertible, these parameters are also determined as a function of a position of the retractable roof of this convertible.

In other words, the air conditioning control unit according to the invention recognizes an operating state which prevails for the particular driving state and pressure state and is assessed to be critical at certain parameter values. If such a critical operating state is present, the air conditioning control unit prevents error storage in a local memory. Furthermore, the air conditioning control unit executes an activation signal which leads to a short switching off of the fan if, in the critical operating state, the speed drops below the threshold speed. This makes it possible to shorten the protective switching-off time of the fan for this extreme case. In other words, if the speed of the vehicle is above a threshold value, error messages of the fan regulator, which could be caused by the effect of the dynamic pressure, are no longer stored.

For example, when windows are closed, this threshold vehicle speed is at approx. 150 km/h while, when windows are open it can be reduced to 120 km/h and, furthermore, when a sliding roof is open, to 100 km/h. In this connection, it is not necessary to provide a graduation with intermediate values, since it is sufficient to use as the particular threshold vehicle speed the lowest threshold value for which the conditions are met. If the current vehicle speed is then reduced below the threshold vehicle speed, the error storage of the air conditioning control unit is activated again.

In order to be able to appropriately detect the individual parameters before they are supplied to the air conditioning control unit for further processing, an air conditioning device according to the present invention has at least one sensor system which is connected to the air conditioning control unit and which detects the position of windows and/or of a sliding roof or a retractable roof of a motor vehicle.

Furthermore, a further sensor system can optionally be provided, which is connected to the air conditioning control unit and which continuously detects the pressure prevailing in the interior. If a pressure sensor is not used, the operation is carried out on the basis of speed limit values which are deposited in the control unit, and which have been defined empirically in vehicle tests.

Furthermore, an additional sensor system is also provided which transmits the current vehicle speed to the air conditioning control unit.

The individual dependencies between the vehicle body openings and the threshold vehicle speed can be realized by simple programming in the air conditioning control unit.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of an air conditioning device according to the invention; and

FIG. 2 is a flow diagram that illustrates the steps of the method according to the invention.

### DETAILED DESCRIPTION OF THE DRAWINGS

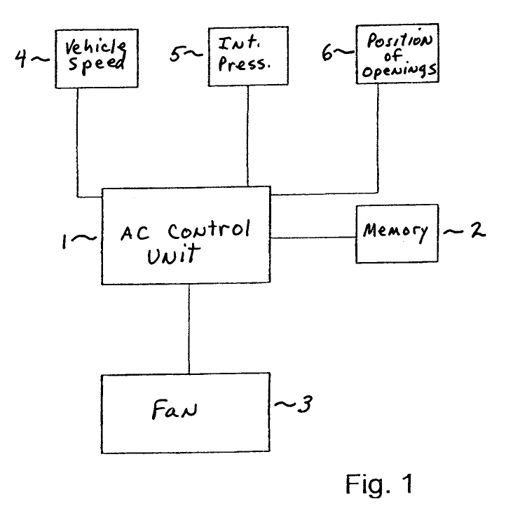

FIG. 1 is a schematic block diagram of an air conditioning device according to the invention, which comprises an air conditioning control unit 1 with an internal memory 2. The air conditioning control unit 1 activates a fan 3 which supplies the interior of a motor vehicle with corresponding air-conditioned air at a corresponding air outlet speed and with the provision of a certain quantity of air.

The air conditioning control unit 1 is connected to a sensor system 4 which records the current vehicle speed. In addition, the air conditioning control unit 1 can also be connected to a sensor 5 which continuously detects the pressure prevailing in each case in the interior of the motor vehicle. Finally, at least one further sensor system 6 is provided which detects the position of different vehicle openings, such as windows, a sliding or tilting roof, or a retractable roof of a convertible.

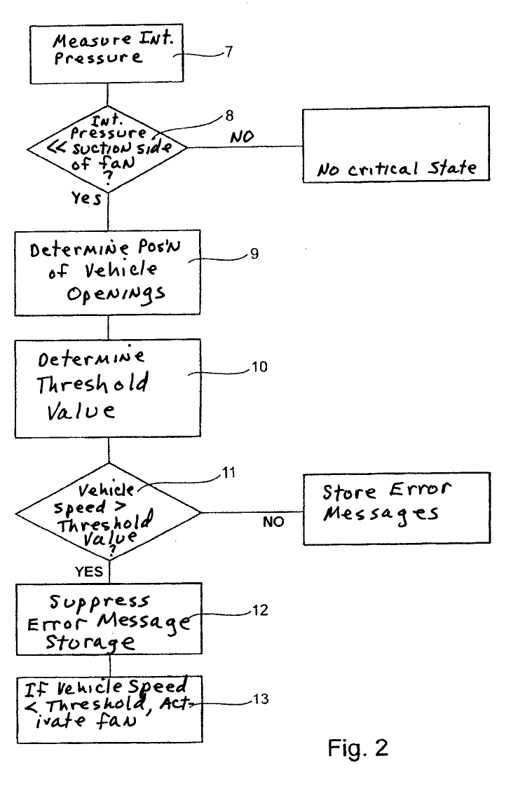

FIG. 2 is a flow diagram that shows the steps of the method according to the invention.

In a first, optional step 7 (which is performed, however, only if the optional sensor 5 is provided), the pressure in the interior of the motor vehicle is detected. If it is substantially lower than the dynamic pressure at the suction side of the fan 3, a critical operating state is recognized by the air conditioning control unit 1 in step 8 (also optional).

In step 9, the individual position of different vehicle openings is detected by the sensor system 4, and the current vehicle speed is determined by the sensor 6. Based on these parameters, a threshold vehicle speed is determined in the air conditioning control unit 1 in the following step 10. In the simplest case, this threshold speed is a constant which covers all possible cases. For this purpose, speed limit values which have been determined empirically in, vehicle tests are stored in the control unit.

In the subsequent evaluation in step 11, the air conditioning control unit 1 determines whether the vehicle speed currently defined in step 9 is greater than the threshold vehicle speed defined in step 10. If so, an error message which could be generated by the air conditioning control unit 1 for this critical operating state is prevented in step 12. Therefore any such error message is not stored in the memory 2.

Thereafter, in step 13, if the speed again drops below the threshold speed, the air conditioning control unit 1 activates the fan, switching it off for a certain period of time and then switching it immediately back on again, such that the vehicle user is unable to notice this.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

1 Air conditioning control appliance
2 Memory of the air conditioning control appliance
3 Fan
4 Sensor for current vehicle speed
5 Optional sensor for pressure of the interior
6 Sensor for position of vehicle openings

1.-7. (canceled)

8. A method for controlling air flow in the interior of a motor vehicle, in which an air conditioning control appliance activates a fan such that air is introduced into the interior at a defined air outlet speed, wherein:
the air conditioning control appliance stores an error message if the fan is unintentionally stopped; and
above a threshold vehicle speed, storage of the error message in the air conditioning control unit is suppressed.

9. The method as claimed in claim 8, further comprising a step in which the air conditioning control unit briefly switches off the fan and immediately switches it on again if the speed drops below a certain threshold vehicle speed.

10. The method as claimed in claim 8, wherein the threshold vehicle speed is determined as a function of position of at least one of a window, a sliding roof and a tilting roof of the motor vehicle.

11. The method as claimed in claim 8, wherein the threshold vehicle speed is determined as a function of position of a retractable roof of the motor vehicle.

12. An air conditioning device for the interior of a motor vehicle, comprising:
a fan which introduces air into a vehicle interior at a certain air outlet speed, and which is activated by an air conditioning control unit; wherein:
at least one sensor system is connected to the air conditioning control unit; and
said sensor system detects position of one of windows, a sliding or tilting roof, and a retractable roof of the motor vehicle.

13. The air conditioning device as claimed in claim 12, wherein:
a further sensor system is connected to the air conditioning control unit; and
said further sensor system detects the current vehicle speed.

14. The air conditioning device as claimed in claim 12, wherein:
a further sensor system is also connected to the air conditioning control unit; and
said further sensor system detects pressure in the interior.
